(19) United States
(12) Patent Application Publication
(10) Pub. No.: US 2015/0165647 A1
(43) Pub. Date: Jun. 18, 2015

(54) METHOD FOR CUTTING A SINGLE CRYSTAL

(71) Applicant: CrystAI-N GmbH, Fuerth (DE)

(72) Inventors: Octavian Filip, Nuernberg (DE); Boris Epelbaum, Aurachtal (DE); Matthias Bickermann, Oberasbach (DE); Albrecht Winnacker, Erlangen (DE); Paul Heimann, Adelsdorf (DE); Ulrich Seitz, Nuernberg (DE)

(21) Appl. No.: 14/407,804

(22) PCT Filed: Apr. 16, 2013
(86) PCT No.: PCT/EP2013/057915

§ 371 Date: Dec. 12, 2014

(30) Foreign Application Priority Data
Jun. 14, 2012 (DE) 10 2012 210 047.4

(51) Int. Cl. B28D 5/04

(52) U.S. Cl. CPC B28D 5/045

(57) ABSTRACT

A method for cutting a single crystal having a first polar axis includes the steps of arranging the single crystal relative to a cutting tool in such a way that the first polar axis is oriented perpendicular to an intended cutting plane; arranging at least one further single crystal having a second polar axis in such a way that the first and the second polar axis are oriented substantially parallel but opposite one another; and simultaneously guiding a cutting tool through the single crystal and the at least one further single crystal along the intended cutting plane.

### RELATED APPLICATIONS

The present application is National Phase of International Application No. PCT/EP2013/057915 filed Apr. 16, 2013, and claims priority from German Application No. 10 2012 210 047.4, filed Jun. 14, 2012, the disclosure of which is hereby incorporated by reference herein in its entirety.

### BACKGROUND OF THE INVENTION

The invention relates to a method for cutting a single crystal having a polar axis.

According to the prior art, it is known, for example from DE 197 29 578 B4, to saw or to cut single crystals into a plurality of thin slices by means of a wire saw. Slices of this type are then machined further, for example by grinding, honing, lapping or polishing. Such further-machined slices or wafers are then processed into semiconductors.

In order to cut out as many slices as possible from a single crystal and also to minimise the outlay of the following machining steps, it is necessary for the sawing or cutting faces of the slices to be planar and to run exactly parallel. When sawing single crystals having a polar axis, there is the problem that the cut faces of the slices have a bend when conventional cutting methods are used. To produce planar surfaces, the slices have to then be ground at high cost.

The object of the invention is to overcome the disadvantages according to the prior art. In particular, a method that can be carried out as easily and cost-effectively as possible for cutting a single crystal having a polar axis into slices with planar cut faces is to be specified.

### SUMMARY OF THE INVENTION

This object is achieved by the features of the first aspect.

Expedient embodiments of the invention will emerge from the features of the second to seventh aspects.

In accordance with the invention, a method is proposed for cutting a single crystal having a first polar axis comprising the steps of:

arranging the single crystal relative to a cutting tool in such a way that the first polar axis is oriented substantially perpendicular to an intended cutting plane;

arranging at least one further single crystal having a second polar axis in such a way that the first and the second polar axis are oriented substantially parallel but opposite one another; and

simultaneously guiding a cutting tool through the single crystal and the at least one further single crystal along the intended cutting plane.

It is possible with the proposed method to cut slices having planar cut faces from a single crystal having a polar axis in a simple and cost-effective manner. At the subsequent grinding process it is just necessary to smoothen the cut surfaces being already planar. The expenditure of time for grinding of the cut surfaces can be drastically reduced therewith.

A further advantage of the method according to the invention lies in the fact that the single crystal can be cut using conventional devices, for example wire saws or the like. A specific mechanistic built-up is not required.

In accordance with the method according to the invention, the further single crystal is used to compensate for a deflection of the cutting tool when producing a cut through the single crystal.

It is assumed that the mutually opposed surfaces have different mechanical properties on either side of the cutting plane running perpendicular to the polar axis. Consequently, a force acting on the cutting tool in the direction of a pole of the polar axis is exerted and deflects the cutting tool in the direction of this pole. The deflection of the cutting tool is compensated for in accordance with the invention in that the cutting tool is guided simultaneously through an adjacently arranged further single crystal having a second polar axis, of which further poles are opposite the poles of the first polar axis. Here, the first and the second polar axis are substantially parallel, that is to say the first and the second polar axes deviate from one another with respect to the parallel orientation by at most 1°, preferably by at most 0.5°.

In accordance with an advantageous embodiment, the at least one further single crystal is geometrically formed such that, as the cutting tool is guided, a first cut length in the single crystal deviates by at most 30% from a second cut length in at least one further single crystal. The first and the second cut length preferably deviate from one another by at most 20%, particularly preferably by at most 15%. It is thus possible to produce particularly planar cut faces.

Furthermore, the single crystal and the further single crystal expediently have a substantially similar geometry. It has proven to be advantageous if a middle first diameter of the single crystal running perpendicular to the first polar axis deviates by at most 30% from a middle second diameter running perpendicular to the second polar axis. The first and the second diameter advantageously deviate from one another by at most 20%, particularly preferably by at most 10%. A particularly efficient production of slices from single crystals having a polar axis can thus be achieved.

In accordance with a further advantageous embodiment, the single crystal and the at least one further single crystal match in terms of their chemical composition. The single crystal and the at least one further single crystal may have, in particular, a chemical composition selected from the following group: AIN, GaN, GaAs, InP. Single crystals having the aforementioned composition have a polar axis. They are present in zinc blende structure, for example GaAs, InP, or wurtzite structure, for example AIN, GaN.

In accordance with a particularly advantageous embodiment, the single crystal and the at least one further single crystal match in terms of the symmetry of their crystal lattice. The further single crystal is expediently one that matches the single crystal both in terms of the symmetry of the crystal lattice and in terms of the composition.

In principle, further single crystals can be provided by any single crystals having a polar axis that are suitable for this purpose. The method according to the invention, however, can be carried out particularly cost-effectively and efficiently if both the single crystal and the at least one further single crystal consist of the material desired for the production of the slices.

In particular, at least one wire, preferably a wire web, of a wire saw can be used as a cutting tool. However, it is also possible to use a hole saw or the like, for example.

The prior art and also exemplary embodiments of the invention will be explained in greater detail hereinafter on the basis of the drawings, in which:

### BRIEF DESCRIPTION OF THE DRAWINGS

FIG. 1 schematically shows a single crystal having a polar axis,

FIG. 2 schematically shows a section through the single crystal according to FIG. 1 in accordance with the prior art,

FIG. 3 shows slices cut in accordance with the prior art,

FIG. 4 shows a schematic first arrangement according to the invention,

FIG. 5 shows a schematic second arrangement according to the invention, and

FIG. 6 shows a schematic third arrangement according to the invention.

### DETAILED DESCRIPTION OF THE INVENTION

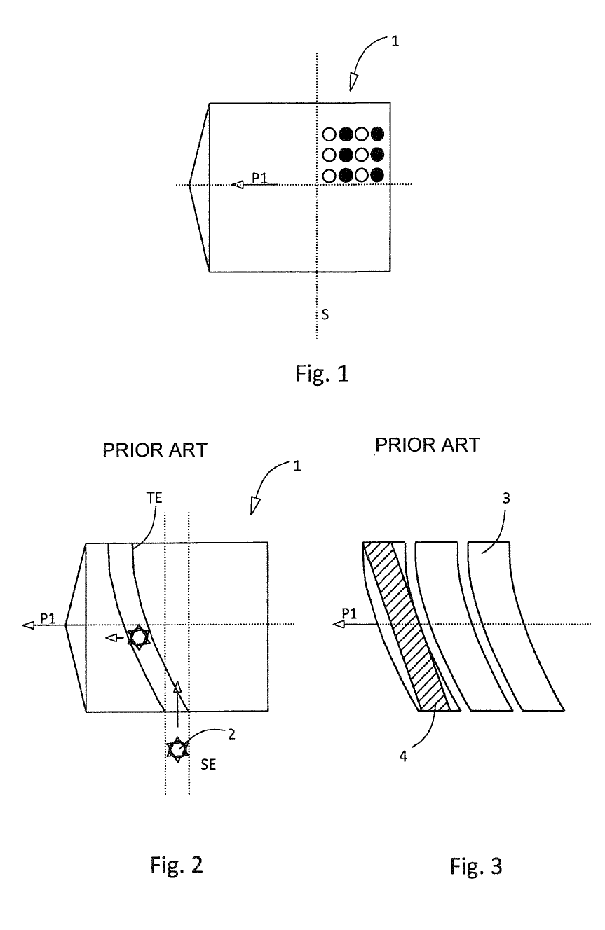

FIG. 1 schematically shows a single crystal 1 having a first polar axis P1. The first polar axis P1 has 2-fold symmetry. The single crystal 1 is not symmetrical with respect to a plane of symmetry S running perpendicular to the first polar axis P1. The single crystal 1 may be, for example, an AlN or a GaN single crystal.

FIGS. 2 and 3 show a method for cutting slices from the single crystal 1 shown in FIG. 1. An intended cutting plane SE is indicated in FIG. 2 by the interrupted lines and runs substantially perpendicular to the first polar axis P1. Reference sign 2 denotes a wire or saw wire, which is guided parallel to the intended cutting plane SE. In practice, the saw wire 2 is deflected, in spite of the guidance thereof, in the direction of the intended cutting plane SE. The actual cutting plane TE shown in FIG. 2 is produced, which is curved and does not run perpendicular to the first polar axis P1. Should the single crystal 1 according to the prior art be sawn using a wire saw having a wire web, slices 3 as shown in FIG. 3 are produced. The surfaces of the slices 3 are curved and do not run perpendicular to the first polar axis P1. In order to produce slices 3 having plane-parallel surfaces, it is necessary to grind these at high cost. In FIG. 3, reference sign 4 denotes a wafer that can be produced by grinding the slices 3.

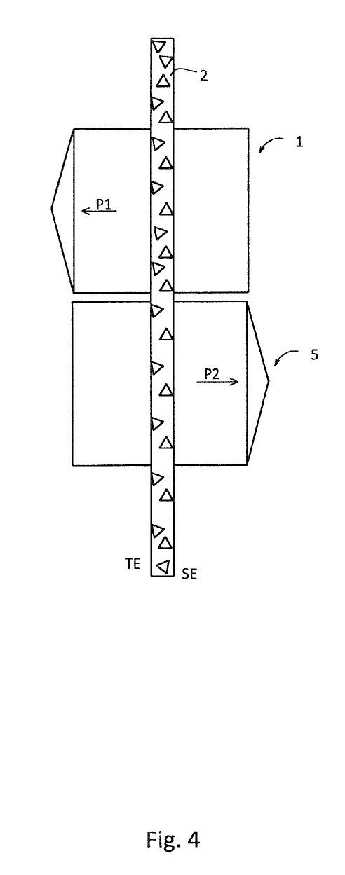

FIG. 4 shows a first arrangement according to the invention. Here, a further single crystal 5 is arranged immediately beside the single crystal 1. The further single crystal 5 has a second polar axis denoted by reference sign P2. The single crystal 1 and the further single crystal 5 are arranged such that the first polar axis P1 and the second polar axis P2 are arranged parallel to one another, however the poles of said polar axes, indicated in each case by an arrow, point in different directions. Both the single crystal 1 and the further single crystal 6 have substantially the same diameter. Consequently, a first cut length produced by the saw wire 2 in the single crystal 1 is substantially identical to a second cut length in the further single crystal 5. A deflection of the saw wire 2 in the single crystal 1 is compensated for by an opposite deflection of the saw wire 2 in the further single crystal 5. On the whole, an actual cutting plane TE is produced for both single crystals 1, 5, which matches the intended cutting plane SE. Consequently, slices having planar opposed surfaces can be cut using the method according to the invention. Grinding work in order to level the surfaces is spared. Compared with the prior art, more slices can be obtained from the single crystal 1.

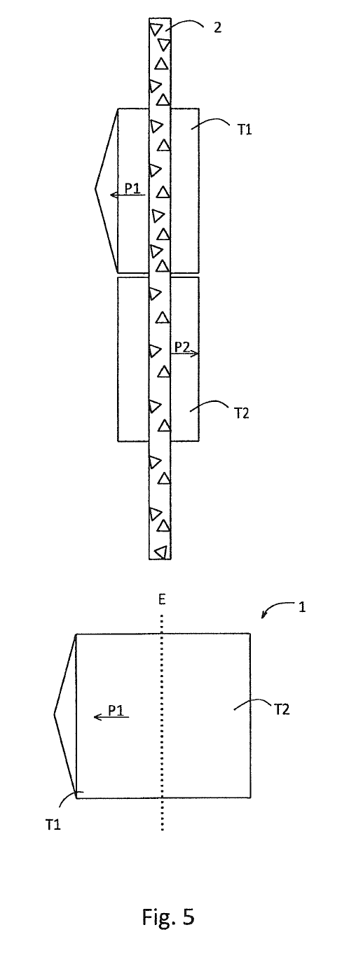

FIG. 5 schematically shows a second arrangement according to the invention. Here, the single crystal 1 is firstly cut along the plane of separation denoted by reference sign E into a first part T1 and a second part T2. The plane of separation E runs here substantially perpendicular to the first polar axis P1. The first part T1 and the second part T2 are arranged one beside the other such that the first polar axis P1 and the second polar axis P2 are oriented parallel to one another, but with opposite polarity. The proposed method is suitable in particular when merely one single crystal 1 is to be cut into slices. Alternatively, it is of course also possible to cut the single crystal 1 parallel to the first polar axis P1 thereof and to then arrange and cut the produced parts again with opposed polarity in accordance with the invention.

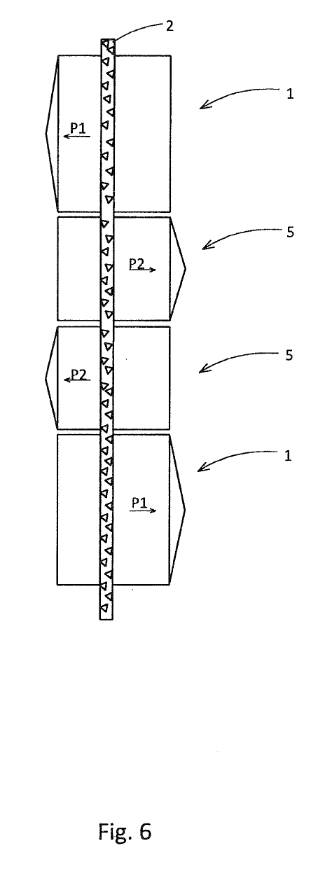

FIG. 6 shows a third arrangement according to the invention. Here, a number of single crystals 1 and a plurality of further single crystals 5 are arranged side by side. The single crystals 1 and the further single crystals 5 are arranged in this case such that the polar axes P1, P2 thereof run substantially parallel to one another. Two adjacent single crystals 1, 5 are always arranged such that the poles of the polar axes P1, P2 point in opposite directions.

Within the sense of the present invention, the term “first cut length” is generally understood to mean the cut length through a single crystal. If a number of single crystals are provided at the same time, the term “first cut length” is understood to mean the sum of the cut lengths produced by all the first single crystals. Similarly, the term “second cut length” in the case of the use of a number of further single crystals is understood to mean the sum of the second cut lengths produced in all the further single crystals.

The method according to the invention can be carried out particularly efficiently if the single crystals 1 and the further single crystals 5 match in terms of their chemical composition and also in terms of their symmetry. It is also advantageous if the single crystals 1, 5 also match substantially in terms of their geometry. In this case, a large number of slices having parallel surfaces can be produced highly efficiently in accordance with the method according to the invention, for example using a wire saw having a wire web.

1. A method for cutting a single crystal having a first polar axis comprising the steps of:
arranging the single crystal relative to a cutting tool in such a way that the first polar axis is oriented substantially perpendicular to an intended cutting plane;
arranging at least one further single crystal having a second polar axis in such a way that the first and the second polar axis are oriented substantially parallel but opposite one another; and
simultaneously guiding a cutting tool through the single crystal and the at least one further single crystal along the intended cutting plane.

2. The method according to claim 1, wherein the at least one further single crystal is geometrically formed such that, as the cutting tool is guided, a first cut length in the single crystal deviates by at most 30% from a second cut length in at least one further single crystal.

3. The method according to claim 1, wherein a middle first diameter of the single crystal running perpendicular to the first polar axis deviates by at most 30% from a middle second diameter of the further single crystal running perpendicular to the second polar axis.

4. The method according to claim 1, wherein the single crystal and the at least one further single crystal match in terms of their chemical composition.

5. The method according to claim 4, wherein the single crystal and the at least one further single crystal have a chemical composition selected from the following group: AlN, GaN, GaAs, InP.

6. The method according to claim 1, wherein the single crystal and the at least one further single crystal match in terms of the symmetry of their crystal lattice.

7. The method according to claim 1, wherein at least one wire, preferably a wire web, of a wire saw is used as cutting tool.
